(19) United States
(12) Patent Application Publication
(10) Pub. No.: US 2022/0211002 A1
(43) Pub. Date: Jul. 7, 2022

(54) Watering Cup with Removable Insert

(71) Applicant: Tyler Phillips, Germantown, MD (US)

(72) Inventor: Tyler Phillips, Germantown, MD (US)

(21) Appl. No.: 17/143,357

(22) Filed: Jan. 7, 2021

(51) Int. Cl. A01K 7/02; G01G 13/02

(52) U.S. Cl. CPC A01K 7/02; G01G 13/024

(57) ABSTRACT

A removable insert for a pet watering device.

### BACKGROUND

Automatically filling cups can be used to provide water for animals. The cup 100 shown in FIG. 1 has a valve 105 which is connected to a water source 106. The valve 105 is spring biased into an upward/closed position, in which water from the source 106 exits the water spout 107, thus filling the water holding area 108 in the cup. The weight of the water in the area 108 in the cup eventually gets heavy enough to overcome the force of a spring 110. This closes the valve, stopping the water flow.

This way, the water cup stays filled.

This can be used, for example, for providing water to animals.

### SUMMARY

The inventor recognized a problem, however, in that the inside of this cup gets dirty over time, and there is no easy way to clean it. A user can attempt to wipe it out, but that is difficult and the cup often needs to be wiped multiple times. Because it is usually attached to a source of water, it is very difficult to remove the cup and clean it, because the water source needs to be removed.

The present application describes an insert for a cup of this type where the insert can be removed and cleaned. All the debris goes inside the cup, and the cup can be easily removed and cleaned.

### BRIEF DESCRIPTION OF THE DRAWINGS

FIG. 1 shows a prior art auto filling cup for an animal or the like;

FIG. 2 shows an insert which fits into the auto filling cup;

FIG. 3 shows the auto filling cup with the insert inside.

### DETAILED DESCRIPTION

An embodiment uses an insert for a self filling cup, where the insert is removable; enabling the removed insert to be cleaned.

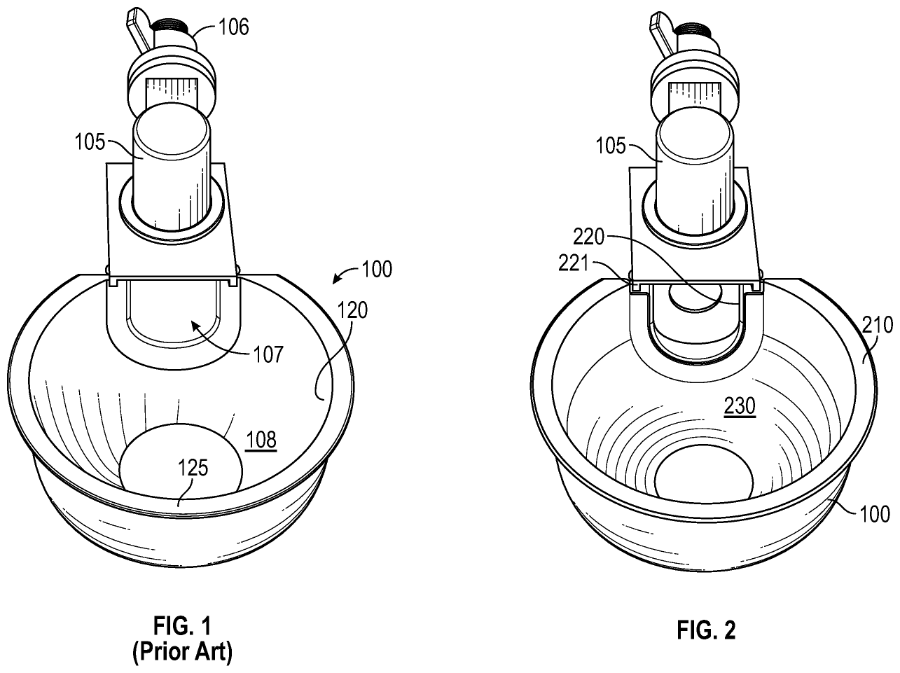

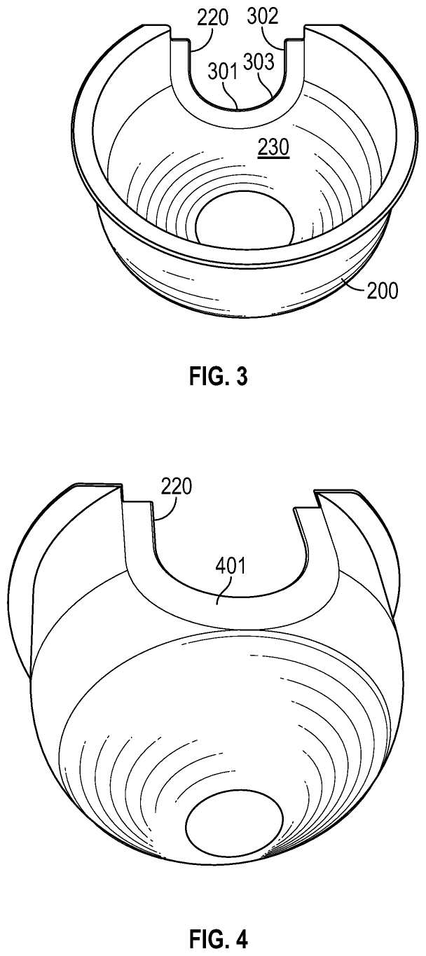

An embodiment is shown in FIG. 2. This may use the cup 100 as shown in FIG. 1, or can use any other watering cup, e.g., any watering cup for animal feeding. The embodiment uses the cup 100.

The inner surface of the cup 100 receives insert 200 which has an outer surface 205 which is smaller than and fits within the inner surface 120 of the cup 100. The top of the insert forms a lip 210 where the lip 210 is longer than the corresponding lip edge 125 of the watering cup 100 and extends over the edge 125. The inside surface of the lip 210 may also include an indent or similar structure to enable the lip 210 of the insert to snap on to, and remain better connected to, the top surface of the cup 100.

The insert 200 also has a cut out section 220 which is a removed area that fits over the area of the cup around the attachment location 221 where the cup connects to the valve 105. The edges of the cut out section 220 fits around the attachment area 210, and further hold and orient the cup insert into place inside the cup. In one embodiment, the edges of the cut out section are horseshoe shaped. In another embodiment, the edges of the cut out section are other shaped, such as v-shaped.

Areas 230 below the level of the cut out area 220 is solid, and holds water. The area 230 below the cut out area is sufficient to hold a sufficient amount of water to hold closed the auto filling valve. This facilitates holding the water in the bottom of the cup, allowing automatic refilling, and allowing removing the cup insert to clean the cup insert.

The cup insert is preferably formed of plastic, and the plastic does not add much weight to the cup, thus allowing the insert to be used without changing the characteristics of the spring.

FIG. 3 illustrates the insert 200, showing its inner surface 230 that is bordered at the top by a cut out surface 220. The cut out surface 220 is has flattened areas 302, tow substantially rounded in shape, starting at the top lip of the cup surface, and extending down in a general rounded shape at 303 to the bottom most portion 301. The bottom most portion 301 still allows enough liquid to be held in the location 230 below that bottom most portion 301, such that the weight of that liquid in that portion will hold down the spring and close the valve.

FIG. 4 illustrates the cup insert from the front, showing the cut out portion 220. The cut out portion or FIG. 4 shows the outside surface of the insert, and how the cut out portion 220 includes a beveled portion 401 where the surface is flattened with a slight rounding, to press flatly against the inside surface of the cup.

Although only a few embodiments have been disclosed in detail above, other embodiments are possible and the inventors intend these to be encompassed within this specification.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An insert for an animal watering device, comprising:
a cup insert, having an outer surface sized to fit within an inner surface of a watering holding device,
the cup insert having surfaces to hold the cup insert inside the watering holding device, and the cup insert being removable from the watering holding device for cleaning, and re-insertable into the watering holding device.

2. The insert as in claim 1, further comprising the watering holding device, and the watering holding device includes a rounded self filling cup for animal watering.

3. The insert as in claim 2, wherein the self filling cup includes an area that connects between a water source and the self filling cup, and where the insert includes a cut out section around the area.

4. The insert as in claim 3, wherein the cut out section is beveled on an outer surface to match a shape of the inner surface of the cup insert.

5. The insert as in claim 2, wherein the insert is formed of a material that does not add sufficient weight to affect a filling of the the self filling cup.

6. The insert as in claim 5, wherein the insert is formed of plastic.

7. The insert as in claim 2, wherein the insert is formed of plastic, and has a weight effective to prevent the insert from changing the weight of the water cup by an amount effective to prevent the self watering cup from filling properly.

8. The insert as in claim 3, wherein the cut out section is at a location which allows sufficient water to be held below a bottom part of the cut out section to still allow the self filling cup to feel sufficiently to stop filling.

9. The insert as in claim 3, wherein the cut out section has a horseshoe shape.
